(19) United States
(12) Patent Application Publication
(10) Pub. No.: US 2014/0238273 A1
(43) Pub. Date: Aug. 28, 2014

(54) GEOPOLYMER PRODUCT

(71) Applicant: HySSIL Pty Ltd, Melbourne, Victoria (AU)

(72) Inventors: Kwesi Kurentsir Sagoe-Crentsil, Aspendale Gardens (AU); Shiqin Yan, Mulgrave (AU); Leigh Gesthuizen, Melbourne (AU)

(21) Appl. No.: 14/348,341

(22) PCT Filed: Sep. 28, 2012
(86) PCT No.: PCT/AU2012/001193

§ 371 Date: Mar. 28, 2014

(30) Foreign Application Priority Data
Sep. 30, 2011 (AU) 2011904043

(51) Int. Cl. C04B 28/00

(52) U.S. Cl. CPC C04B 28/006
USPC 106/624

(57) ABSTRACT

A method of producing a geopolymer product, which comprises: preparing an activated geopolymer premix by addition to a geopolymer premix of an activator compound that initiates a condensation reaction in the geopolymer premix; forming the activated geopolymer premix into a desired configuration to form a geopolymer structure; and curing the geopolymer structure to produce the geopolymer product, wherein the characteristics of the activated premix are controlled and the condensation reaction allowed to proceed for a period of time prior to forming such that when formed the activated premix forms a self-supporting geopolymer structure.

### TECHNICAL FIELD OF THE INVENTION

The present invention relates to a geopolymer product, to a method of making the product and to uses of the product.

### BACKGROUND OF INVENTION

Concrete and clay tile roofing systems are durable, aesthetically appealing, and low in maintenance. They are also energy efficient, helping to maintain liveable interior temperatures (in both cold and warm climates) at a lower cost than other roofing systems. Importantly, they can be mass-produced by extrusion processing. However, cement-based products tend to exhibit a relatively large carbon footprint since the production of constituent ingredients tends to be energy intensive.

Against this background the industry continually pursues at least comparable product performance with minimal environmental footprint and cost penalties.

The present invention is discussed with particular reference to roof tiles as the product of interest, but the present invention may be applied to produce other extruded products having desirable characteristics.

### SUMMARY OF THE INVENTION

Accordingly, in one embodiment the present invention provides a method of producing a geopolymer product, which comprises:

preparing an activated geopolymer premix by addition to a geopolymer premix of an activator compound that initiates a condensation reaction in the geopolymer premix;

forming the activated geopolymer premix into a desired configuration to form a geopolymer structure; and curing the geopolymer structure, wherein the characteristics of the activated premix are controlled and the condensation reaction allowed to proceed for a period of time prior to forming such that when formed the activated premix forms a self-supporting geopolymer structure.

Herein the term geopolymer denotes a mineral/inorganic polymer. Geopolymers and their formation is generally known in the art.

In accordance with the present invention the properties of the activated geopolymer are controlled so that (a) it is susceptible to being formed into a desired configuration (shape and profile) (b) after this forming the premix is self-supporting and c) the product achieves target performance properties at least comparable to conventional Portland cement products. In this respect the term “self-supporting” is intended to mean that once formed the geopolymer structure retains its structural integrity and dimensional stability, i.e. the as-formed shape profile and dimensions are maintained. It is important that the as-formed geopolymer structure retains its structural integrity and dimensional stability up until curing to obtain a final geopolymer product.

Herein the term “forming” is used to denote mechanical deformation of the activated geopolymer into a desired configuration (shape and profile). Typically, this forming will include one or more of extrusion, moulding and pressing in order to produce a pre-cured structure having the desired shape.

The present invention also provides a geopolymer product when produced in accordance with the present invention, ie. a cured geopolymer product.

Also provided is the use of a geopolymer product in accordance with the present invention as a building/construction component. The geopolymer product of the invention may be used instead of conventional cement-based building/construction materials, taking into account of course the properties of the product and the intended usage. The products of the present invention may have particular utility as roof tiles due to their light weight and beneficial mechanical properties. Geopolymers (geopolymer binders) have the potential to offer material and process cost benefits for concrete roof tiles, when evaluated on a cost versus performance basis, compared to conventional concrete and clay roofing products.

It has been found that geopolymer roof tiles with high strength, good freeze/thaw durability and excellent thermal insulation, and heat preservation properties can be produced using extrusion processing that has conventionally been applied to producing cement-based materials. However, in accordance with the present invention it is important to control the reaction kinetics and chemistry and accordingly the premix constituents and formulation/mixing methodology. The use of mould pressure forming techniques can also produce geopolymer roofing tiles of excellent dimensional accuracy.

The present invention may be used to produce roof tiles of having a range of densities for example from 1500 to 2400 kg/m³. Thus, the invention may be applied to produce roof tiles of conventional density as well as lightweight and ultra-lightweight roof tiles.

In addition to potential materials and process savings during manufacture, geopolymer roof tiles are likely to have significant environmental advantages since the use of geopolymer binders can offer up to 70% CO₂ emissions savings compared to conventional Portland cement (OPC) binders. The raw feedstock of geopolymer binders is derived from industrial waste materials such as fly ash generated from coal fired electricity generating power plants. Thus, geoploymers do not deplete limited natural resources and can be produced without the use of chemical preservatives. They may also have superior mechanical properties, including breaking strength (or modulus of rupture). Roof tiles produced in accordance with the invention may have a breaking strength of from 1.3 to 3.50 MPa determined by standard 3-point bending tests.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### BRIEF DISCUSSION OF DRAWINGS

Embodiments of the present invention are illustrated with reference to the accompanying non-limiting drawing in which:

FIG. 1 is a flow chart illustrating how the process of the invention may be implemented.

### DETAILED DISCUSSION OF THE INVENTION

The present invention relies on controlling the rheological properties of the activated geopolymer premix prior to, during and immediately following the forming (mechanical deformation) step. To be capable of being shaped as desired the premix must be capable of being suitably deformed by a die or mould under pressure. This deformation is plastic in nature. After the compressional forces associated with forming have been removed the premix must be self-supporting. This property will be related to the extent to which the condensation reaction has progressed and the premix (partially) stiffened as a result. If the as-formed product is not self-supporting, it will either relax and lose its structural and dimensional stability or crumble/disintegrate, prior to curing. Neither of these possibilities is acceptable. Rather, the consistency of the premix must be such that it can be suitably deformed on forming so as to conform to a desired shape (be that using a die or a mould) and that it retains that desired shape after compressional forces associated with forming have been removed. As the condensation reaction proceeds the consistency and pliability of the premix will change. There is therefore a rheology envelope/window that is most suitable for forming of the premix into a desired shape and profile.

It has also been found that the extent of mixing of the geopolymer premix and activator compound may be influential in achieving the desired results. Excessive mixing has been found to lead to the formation of agglomerates that do not adhere together in the as-formed product. This may be due to excessive condensation during the mixing step.

Forming itself is carried out in conventional manner using conventional equipment. In an embodiment of the present invention, the activated geopolymer premix is delivered into a mould having a suitable profile. The mould is over-filled slightly and then the activated geopolymer premix pressed into the mould so that the entirety of the cavity of the mould is suitably filled. This may be done using one or more suitably positioned rollers that have the effect of squeezing the activated premix into the mould.

The mould may be made of any suitable material noting that the mould is preferably re-usable. It is possible that the mould may be formed of a material that reacts with the activated premix, such as aluminium, and in this case parts of the mould that are likely to contact the activated premix may be treated with a suitable barrier or release agent to prevent chemical reaction between the mould and the activated premix. This assists with productivity (wastage of product due to interaction of premix with the mould is minimised or avoided) and makes the product easier to remove from the mould after curing. When the mould is formed of aluminium the barrier/release agent may comprise various oils such as aliphatic compounds and (natural or synthetic) waxes. Other release agents such as PVA or related compounds may also be useful.

Geopolymer binder synthesis basically involves the reaction silica and alumina species with alkalis and alkali-polysilicates to form an aluminosilicate gel network structure through a dissolution and condensation reaction process. The principal raw feedstock materials required for this class of binders are derived from both extractive and processing mineral resources such as fly ash or slag. Without wishing to be bound by theory, in accordance with the present invention it is desirable that the dissolution reaction is complete, or substantially complete, prior to forming taking place. This will be related to the manner in which and the timing with which the constituents of the premix are mixed together. Immediately prior to forming the condensation reaction will have commenced and it is important that the condensation reaction has progressed to a significant extent in the as-formed product as this will result in the product having desirable mechanical properties in addition to being structurally and dimensionally stable. These mechanical properties can then be further enhanced by curing of the product.

The properties of geopolymer binder systems are largely controlled by the reaction chemistry of SiO₂, Al₂O₃ and other minor oxides present in its highly alkaline environment. The factors controlling geopolymer binder performance hinge on materials selection and process route adopted for geopolymer synthesis. In particular, the type, fineness and chemical composition in terms of ratio of oxide components of the feedstock material (typically fly ash or metakaolin), and concentration of alkali silicate activator, water content, and cure conditions play a major role in both microstructure development and tailoring of engineering properties of the geopolymer binder product.

The geopolymerisation reaction involves an initial dissolution step in which Al and Si ions are released in the alkali medium. Transport and hydrolysis of dissolved species are followed by a polycondensation step, forming 3-D network of silico-aluminate structures. These structures can be of three types: Poly (sialate) (—Si—O—Al—O—), Poly (sialate-siloxo) (Si—O—Al—O—Si—O), and Poly (sialate-disiloxo) (Si—O—Al—O—Si—O—Si—O).

The chemical processes governing polymerization reactions of Al₂O₃ and SiO₂ in these systems are largely controlled by stability of the respective speciated phases. Xray diffraction (XRD) analysis shows gepolymers to be largely amorphous although there is published evidence of occurrence of possible nanocrystalline particles of zeolitic origin, within the geopolymermatrix structure. Correspondingly, in the alkaline aqueous solutions of geopolymers, aluminium is present mostly as monomeric aluminate ions [Al(OH)₄]⁻, Thus, all the aluminium present in solution is in IV-fold coordination irrespective of the coordination of the aluminium in the precursor. Silicon by contrast forms a variety of oligomeric ions, particularly at high concentrations and high SiO₂/M₂O (M=Na,K) ratios.

Unlike the well understood roles of oxide components comprising the hydrated gel phases present in CaO—Al₂O₃—SiO₂ systems i.e., Portland and pozzolanic cements, the equivalent contributions of oxide components governing polymerisation reactions and, hence geopolymer properties are now only beginning to emerge. Accordingly, the reaction pathways required to achieve desired engineering performance of geopolymer systems is becoming increasingly important.

While aspects of physical and chemical property relationships of generic geopolymer systems have been investigated, the need exists to extend such studies to cover raw materials selection, process conditions through to large scale production issues. The mixing stage of proportioned solid and liquid feedstock components of geopolymer systems initiate an immediate dissolution process. Depending on the pH regime and oxide concentrations, the resultant species in the liquid phase may comprise monomeric [Al(OH)₄]⁻, [SiO₂(OH)₂]²⁻ and [SiO(OH)₃]⁻ or similar. These subsequently condense with each other. It should be noted that the condensation between Al and Si species occurs more readily due to the characteristic high activity of species such as [Al(OH)₄]⁻. For [SiO(OH)₃]⁻ and [SiO₂(OH)₂]²⁻, although the latter species is more capable of condensing with [Al(OH)₄]⁻ since there exists a larger attraction, they are likely to produce only small aluminosilicate oligomers. The above discussions are summarized in the synthesis pathway as given below:

At the onset of mixing, solid aluminosilicate components dissolve releasing aluminate and silicate ions into solution, with concurrent hydrolysis reactions of dissolved ions. The aluminate and silicate species subsequently begin the condensation process, initially giving aluminosilicate monomers and perhaps oligomers. These ions further condense with one another to produce a gel phase while the mixture starts to set. Condensation reactions continue within the gel phase with the silicate/aluminate ions continuing to dissolve from the solid and onset of initial hardening. Re-dissolution of the gel and precipitation of less soluble and more stable aluminosilicate species may occur while the geopolymer hardens completely as condensation reactions rapidly escalates.

Over a long period of time, the condensation reactions continue but at a decreasing rate. The rigidity of the gel and reduced free water greatly reduce the rate of dissolution of the original aluminosilicate solid.

The present invention takes into account these reaction features and the associated physical changes to enable the geopolymer premix to be formed to provide a product with structural and dimensional stability. This product can then be cured to provide a final product. Preferred curing conditions include 45-85° C. at a relative humidity of at least 50%, preferably from 65-95% and for a duration of 2.5-12 hours. Curing at ambient temperature may of course be possible depending upon prevailing conditions and flexibility with cure duration.

The variety of complex microstructures that characterize geopolymer systems depends on selected mix composition. It is apparent that there is a maximum SiO₂/Al₂O₃ ratio which is favourable in producing high strength geopolymers. Accordingly, the most favourable SiO₂/Al₂O₃ molar ratio for geopolymer strength is generally greater than 2.0, preferably about 3.8 depending upon source materials. For this, Na₂O/Al₂O₃ ratio is about unity.

In another embodiment of the present invention it has been found that the water content of a geopolymer premix (attributable to various constituents of the premix) will have an impact on the properties of a geopolymer product on completion of the condensation reaction. Thus, if there is too much water present in the premix, this dilutes the alkalinity and this can interfere with the dissolution reaction required in formation of the geopolymer. As a result the geopolymer does not form as it should resulting in intrinsically poor properties. Water is typically intrinsically bound to the aggregate that is used and different aggregates will contribute different amounts of water to the premix. Expanded shale, for example, can absorb a relatively large amount of water or it can have a relatively high intrinsic water content. In accordance with this aspect of the invention the impact of excessive water can be mitigated by boosting the alkalinity (concentration of hydroxide ions) of the premix. This embodiment of the present invention may allow increased latitude for materials selection since it will enable geopolymers with desirable properties to be obtained from components that would otherwise not be suitable for forming geopolymers due to the moisture content they introduce. This embodiment of the invention may be generally applicable to the formation of geopolymers, but may equally be applied in the context of forming a product in accordance with the present invention.

The problem noted above has been found to occur in premix formulations in which the water content of the aggregate component is typically above 2.0 wt % based on the total weight of aggregate. Such formulations will have a concentration of hydroxide ions that can be measured or determined by calculation. It has been found that it is concentration of hydroxide ions that render such formulations poorly performing due to the effect this has on geopolymerisation reaction chemistry. In contrast premix formulations that have a lower water content provided by the aggregate component and that give desirable geopolymer properties will have a characteristic SiO₂ to Na₂O molar ratio ranging from 1.3 to 1.7. This will be higher than corresponding formulations with a higher aggregate water content due to dilution effects. Thus, an embodiment of the present invention involves remediating a premix formulation with an undesirably high water content such that it has an increased hydroxide ion, concentration thereby enhancing product properties. In this embodiment it may be desirable to manipulate the hydroxide ion concentration so that it is at least comparable to premix formulation(s) that have the lower water content and that yield products with satisfactory properties. In this regard, the latter premix formulation(s) exhibit what might be regarded as a “target” hydroxide ion concentration in terms of SiO₂ to Na₂O molar ratio being from 1.3 to 1.7. Premix formulations with unduly high water contents can be dosed with an alkali in order to achieve the “target” hydroxide ion concentration. Purely by way of example, a premix formulation that has a low water content and that may be used for modelling purposes to derive a “target” hydroxide ion concentration might include the following components: aggregates (with moisture content 0-3 wt %) 55.2 wt %; fly ash 27.2 wt %; silicate solution 15.2 wt %; alkaline silicate/alkaline, hydroxide 2.5 wt %. In practice, the moisture content of a given aggregate may be determined (for example, by simple weight measurement before and after heating to drive off water) and the premix composition adjusted as necessary to compensate for the water content. This is preferable to drying aggregate to reduce water content. Drying is not economical on a large scale. For a given set of premix ingredients the formulation chemistry may be optimised for use in the present invention, including pH adjustment based on water content.

The geopolymer product produced in accordance with the invention may be prone to efflorescence, i.e., the formation of salt deposits on or near the product surface causing discoloration. Whilst not believed to be detrimental to produce properties, these salt deposits are unsightly and the premix from which the product is formed may include an additive to prevent efflorescence. Useful additives are known in the art and include calcium aluminates, cement, metakaolin, calcium formate and aqueous water repellents, such as glycerol. Additionally, or alternatively, efflorescence can be minimised or prevented by application of a surface coating, such as an acrylic coating, to the product. Efflorescence may be caused by ingress of water into the product and the coating is therefore applied to those surfaces of the product that in use are likely to come into contact with water.

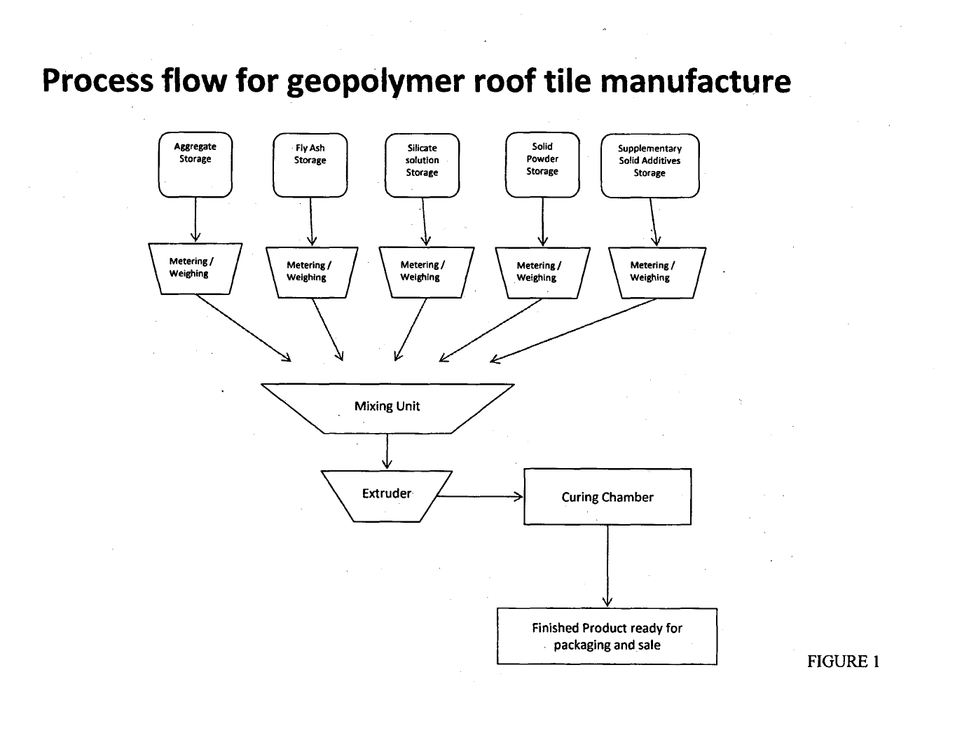

FIG. 1 shows the various steps typically employed in implementing the present invention. According to this figure a premix is formulated by blending of various ingredients from (aggregate, fly ash etc.). Each component is weighed/metered and delivered into a mixing cast. As mixing proceeds, the premix rheology will reach an optimum so that the premix is ready for forming into a desired shape profile. The point in time at which premix is transferred from the mixing unit to the forming device (extruder in FIG. 1) will vary as between different formulations and can be determined for a given formulation by experimentation. The time taken to deliver the premix to the forming device (e.g. extruder) and the forming characteristics will also be relevant here since the condensation reaction in the premix is on-going. After forming, the product may be cut into desired lengths (this step not shown) before the product is conveyed to a curing chamber for curing. After curing, the finished product is ready for packaging and sale. Of course, for efficiency, the process will be automated. The invention may have particular utility in preparing roof tiles and one skilled in the art will understand how to incorporate the invention into a commercial operation for roof tile production.

This embodiment could be put into practice using solid silicate ingredients to adjust alkalinity. However, the solids have been found to have limited performance when compared with solubilised silicate additives.

Embodiments of the present invention are illustrated with reference to the accompanying non-limiting example.

### Example 1

### Geopolymer Mix

| Aggregate moisture content (wt %) | 0 to 3 |
|---|---|
| Aggregate | 55.2% |
| Fly Ash | 27.2% |
| Silicate Solution | 15.2% |
| Alkali silicate/alkaline hydroxide | 2.5% |
| Sum | 100% |

Mixing of Materials

The optimum mix process is as follows:

Step 1—Blend fly ash and aggregate under typical blending methods.

Step 2—Mix the solid powder with the fly ash and aggregate blend via a similar method noted in point one.

Step 3—Add the silicate solution with the fly ash and aggregate and mix thoroughly.

Step 4—Add the colour additive as required immediately following the addition of the silicate solution.

Step 5—Mix all the ingredients thoroughly.

The disclosed procedure ensures the mix is homogeneous and the chemicals are evenly distributed through the mixture to maximise the strength of the finished product.

### Example 2

The tables below give details of premix formulations that may be employed to produce standard weight roof tiles, lightweight roof tiles and ultra-lightweight roof tiles, depending upon mix composition.

Mix Design for Standard Weight Tiles (Proportion in Mass)

| | |
|---|---|
| Sand | 2500-3100 |
| Fly ash | 500-788 |
| Sodium silicate (usually about 50% | 250-450 |
| water) | |
| Alkali hydroxide | 0-55 |
| Supplementary solid additives | 0-65 |
| Efflorescence control admixture | 3-12 |

Mix Design for Lightweight and Ultra-Lightweight Tiles (Proportion in Mass)

| | |
|---|---|
| Lightweight aggregates (shale etc.) | 1200-1650 |
| Fly ash | 500-1150 |
| Sodium silicate (usually about 50% | 350-750 |
| water) | |
| Alkali hydroxide | 0-50 |
| Supplementary solid additives | 0-65 |
| Efflorescence control admixture | 3-12 |

1. A method of producing a geopolymer product, which comprises:
preparing an activated geopolymer premix by addition to a geopolymer premix of an activator compound that initiates a condensation reaction in the geopolymer premix;
forming the activated geopolymer premix into a desired configuration to form a geopolymer structure; and
curing the geopolymer structure to produce the geopolymer product,
wherein the characteristics of the activated premix are controlled and the condensation reaction allowed to proceed for a period of time prior to forming such that when formed the activated premix forms a self-supporting geopolymer structure.

2. The method of claim 1, wherein the geopolymer product is a roof tile.

3. The method of claim 1, wherein curing takes place under conditions of 45-85° C. at a relative humidity of at least 50% for a duration of 2.5-12 hours.

4. The method of claim 1, wherein aggregate in the geopolymer premix has a water content of 2.0 wt % or less based on the total weight of aggregate.

5. The method of claim 1, wherein aggregate in the geopolymer premix has a water content of greater than 2.0 wt % based on the total weight of aggregate and an additive is included in the premix in order to boost alkalinity of the premix.

6. The method of claim 5, wherein the additive achieves in the premix a SiO₂ to Na₂O molar ratio of from 1.3 to 1.7.

7. The method of claim 1, wherein the geopolymer premix comprises an additive to control efflorescence in the geopolymer product.

8. A geopolymer product when produced in accordance with the method defined in claim 1.
